(19) United States
(12) Patent Application Publication
(10) Pub. No.: US 2025/0287425 A1
(43) Pub. Date: Sep. 11, 2025

(54) MANAGED ON-CHANNEL PEER-TO-PEER (P2P) GROUPS AND ASSOCIATED ACCESS MECHANISMS

(71) Applicant: MaxLinear, Inc., Carlsbad, CA (US)

(72) Inventors: Iñaki Val Beitia, Vitoria (ES); Sigurd Schelstraete, Menlo Park, CA (US); Marcos Martínez Vázquez, Barcelona (ES)

(73) Assignee: MaxLinear, Inc., Carlsbad, CA (US)

(21) Appl. No.: 19/074,256

(22) Filed: Mar. 7, 2025

Related U.S. Application Data
(60) Provisional application No. 63/563,186, filed on Mar. 8, 2024.

(51) Int. Cl. H04W 74/0808; H04W 72/0446

(52) U.S. Cl. CPC H04W 74/0808; H04W 72/0446

(57) ABSTRACT

Technology is disclosed for an access point (AP). The access point may include a processing device. The processing device may identify, at the AP, a peer-to-peer (P2P) group comprising a first station (STA) and a second STA. The processing device may generate, at the AP, a shared gained transmission opportunity (TXOP) for the first STA and the second STA. The processing device may send, from the AP to the first STA and second STA, a trigger frame including the shared gained TXOP.

### RELATED APPLICATION

This application claims the benefit of U.S. Provisional Application No. 63/563,186, filed Mar. 8, 2024, the disclosure of which is incorporated herein by reference in its entirety.

The examples discussed in the present disclosure are related to managed peer-to-peer groups and associated access mechanisms for access points (APs) and stations (STAs).

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### BRIEF DESCRIPTION OF THE DRAWINGS

Examples will be described and explained with additional specificity and detail through the use of the accompanying drawings in which:

FIG. 1 illustrates an example wireless local area network environment for peer-to-peer (P2P) communication for a first station (e.g., a laptop) and a second station (e.g., a printer) over transmission control protocol (TCP), exchanging data (D) and acknowledgement (A) frames over a P2P link.

FIG. 2 illustrates an example timing diagram for packet exchange for triggered transmission opportunity (TXOP) sharing mode 2.

FIG. 3 illustrates an example wireless local area network environment for P2P bidirectional data exchange for a P2P group of three devices.

FIG. 4 illustrates an example timing diagram showing a packet sequence for P2P bidirectional data exchange using triggered access mechanisms.

FIG. 5A illustrates an example timing diagram showing a packet sequence for P2P bidirectional data exchange (without acknowledgment (ACK)) using light-weight contention access mechanism.

FIG. 5B illustrates an example timing diagram showing a packet sequence for P2P bidirectional data exchange (with ACK) using light-weight contention access mechanism.

FIG. 6A illustrates an example timing diagram showing a packet sequence for P2P bidirectional data exchange using a light-weight contention access mechanism.

FIG. 6B illustrates an example timing diagram showing a packet sequence for P2P bidirectional data exchange using a light-weight contention access mechanism.

FIG. 7 illustrates an example timing diagram showing a packet sequence for P2P bidirectional data exchange (with ACK) using token-based access mechanism.

FIG. 8 illustrates a block diagram of an example system configured to perform P2P communication.

FIG. 9 illustrates an example process flow for P2P communication.

FIG. 10 illustrates an example process flow for P2P communication.

FIG. 11 illustrates an example process flow for P2P communication.

FIG. 12 illustrates a diagrammatic representation of a machine in the example form of a computing device within which a set of instructions, for causing the machine to perform any one or more of the methods discussed herein, may be executed.

### DESCRIPTION

There exist different applications that use two or more (non-AP) devices (e.g., wireless stations (STAs)) to communicate within the same local area network (LAN), such as document printing, file transfer, internal video streaming, photo viewing, and virtual reality among others. The actual communication may be done directly or through an intermediate device. In the case of Wi-Fi® technology, the STAs may not be allowed to directly communicate with each other. Therefore, the Access Point (AP) may be an intermediary, where the AP may transfer the data from one device to another, using consecutive uplink (UL) and downlink (DL) data transactions. That is, the AP may centralize communication in a shared media.

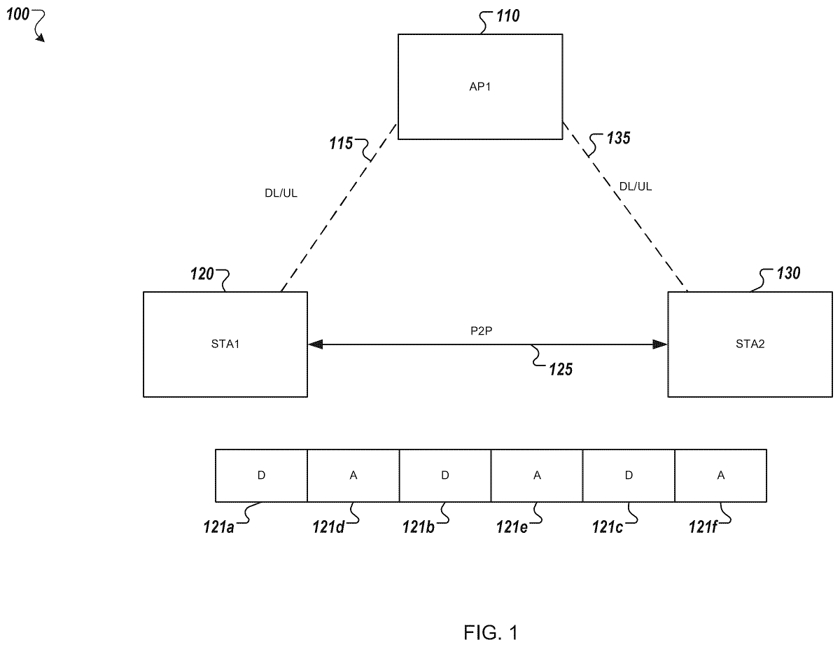

This method may be inefficient for this kind of application, where more direct communications between the devices may speed up the throughput and reduce the airtime employed for the communication. To this end, peer-to-peer (P2P) communication was established, allowing direct communication between two STAs for a limited period of time. As illustrated in FIG. 1, a wireless system 100 may include a STA1 120 (e.g., a laptop) and STA2 130 (e.g., a printer) that may be associated with AP1 110 (i.e., using a first link 115 and a second link 135, respectively), but may communicate directly with each other through a P2P link 125. The communication between STA1 120 and STA2 130 may use transmission control protocol (TCP) which may be used to exchange data frames 121a, 121b, 121c and acknowledgment frames 121d, 121e, 121f over the P2P link 125.

The 802.11be amendment defines the Triggered Transmission opportunity (TXOP) sharing mechanism, allowing the AP to share its gained TXOP with a specific STA, allowing that STA to use this time for transferring data to the AP (mode 1) or transferring data to another STA (mode 2). A P2P link may be established, without using an AP to transfer data and in a contention-free situation, when the TXOP has been granted to the STA.

For P2P applications, a TCP protocol may be used for sending the data, which may use bidirectional exchange of data/(TCP) ACK frames, providing the data transfer, and adapting the protocol to the channel status (e.g., as illustrated in FIG. 1). Other applications, even when TCP is not used, may be based on closing a data loop that may use bidirectional communication. For example, virtual reality glasses receive video and audio, but may also send back the position of the glasses for adapting the video image in the next frame.

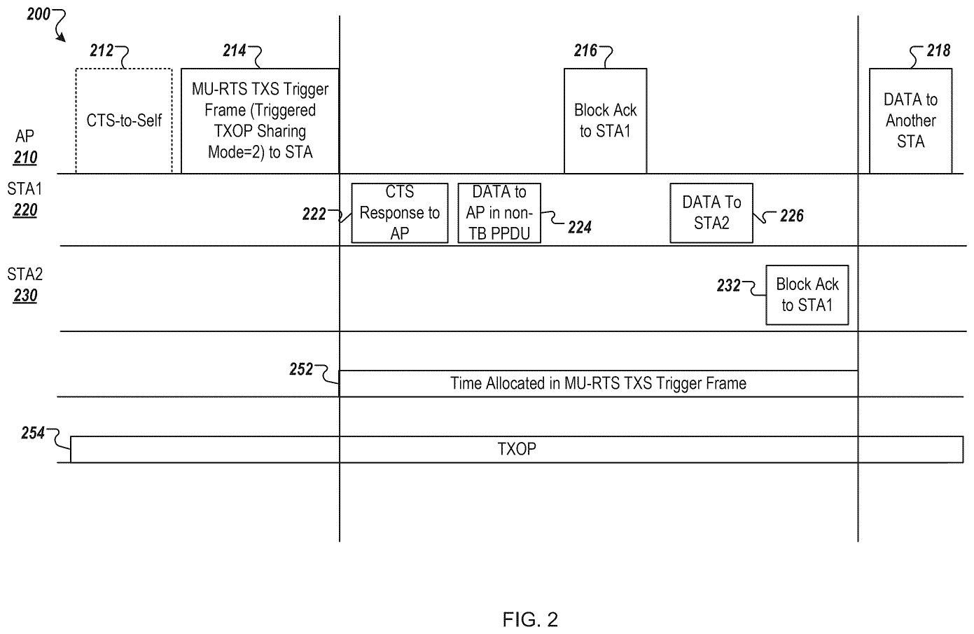

The triggered TXOP sharing (mode 2) mechanism may be limited to transferring data in one direction, as illustrated in FIG. 2. The granted STA can send data to another STA, but the STA cannot receive data from another one, as it does not have the mechanisms such as trigger frames. The following text from the IEEE 802.11be D5.0 discloses:
The non-AP EHT STA may use the time allocated by the associated AP in an MU-RTS TXS Trigger frame, which is addressed to the STA and that has the Triggered TXOP Sharing Mode subfield equal to 2, for the transmission of one or more non-TB PPDUs that are addressed to the AP or to another STA. The non-AP EHT STA that received an MU-RTS TXS Trigger frame with TXOP Sharing Mode subfield equal to 2 may transmit, within an allocated time, a QoS Data or QoS Null frame that includes an HE variant HT Control field with a CAS Control subfield with the RDG/More PPDU subfield equal to 0 to the associated AP from which it has received an EHT Capabilities element with the TXOP Return Support in TXOP Sharing Mode 2 subfield set to 1. Otherwise, the STA shall not transmit such frame to its associated AP within the allocated time.

As illustrated in FIG. 2, a block diagram 200 provides the functionality for the triggered TXOP sharing (mode 2) mechanism which may be limited to transferring data in one direction. The AP 210 may send a clear-to-send (CTS)-to-self signal, as shown in operation 212, to itself. The AP 210 may send a multi-user request-to-send (MU-RTS) TXOP sharing (TXS) trigger frame, which may be triggered TXOP sharing mode 2, to a STA1 220 and a STA2 230, as shown in operation 214. The STA1 220 may send a CTS response to AP to the AP 210, as shown in operation 222. The STA1 220 may send data to the AP 210 in non-trigger-based physical layer protocol data unit (TB PPDU), as shown in operation 224. The AP 210 may send a block ACK to STA1 220, as shown in operation 216. The STA1 220 may send data to the STA2 230, as shown in operation 226. The STA2 230 may send a block ACK to the STA1 220, as shown in operation 232. The time allocated in the MU-RTS TXS trigger frame may include the time between: (i) after the sending of the MU-RTS TXS trigger frame, and (ii) after the sending of the block ACK to the STA1 220, as shown in block 252. The TXOP 254 may include the time from between: (i) the beginning of the sending of the CTS-to-Self as shown in operation 212, and (ii) the end of the sending of data from the AP to another STA, as shown in block 218.

In summary, the TXOP sharing (mode 2) mechanism does not provide optimal functionality for directly communicating two (or more) STA devices that use bidirectional data exchange.

Disclosed herein are coordinated scheduling mechanisms for creating and managing P2P groups of two or more STA devices, reducing the overhead in the access point, and establishing a unidirectional or bidirectional communication in a controlled environment.

There are several mechanisms for allowing bidirectional communication of P2P group members, reducing the overhead generated by MU TXOP sharing mode 2. First, light-weight contention mechanism may allow the P2P group devices to communicate directly without the intervention of the AP, allowing bidirectional communication between the P2P group members. Second, token-based mechanisms may allow the P2P group devices to communicate directly without the intervention of the AP, allowing bidirectional communication between the P2P group members. Third, there may be a fixed order of data transmission so that the contention may be removed, and fixed inter-frame space (IFS) separation between the frames may be set.

Examples of the present disclosure will be explained with reference to the accompanying drawings.

### P2P Groups:

The triggered TXOP sharing (mode 2) mechanism may send data in one direction during the granted TXOP but may not send data in the opposite direction. A mechanism may be used that eases the bidirectional data transfer between the two (or more) non-AP STAs in order to cover the application service standards. For a specific shared TXOP, a group of P2P STAs may be involved in a communication service.

An AP may include a processing device that may; identify, at the AP, a P2P group including the first STA and the second STA; generate, at the AP, a shared gained transmission opportunity (TXOP) for the first STA and the second STA; and send, from the AP to the first STA and second STA, a trigger frame including the shared gained TXOP. The processing device may receive, at the AP from a first STA, a first stream classification service (SCS) request; and/or receive, at the AP, from a second STA, a second SCS request. The first SCS request and/or the second SCS request may be extremely high throughput.

The trigger frame may be a multi-user request-to-send (MU-RTS) TXOP sharing (TXS) trigger frame. The P2P group may be identified using a group identifier (GID). The GID may be sent in the MU-RTS TXS trigger frame. The P2P STAs may join the GID in a previous negotiation and the associated STAs may collect the GID to request resources to the sharing AP.

In one example, there may be a discovery phase in which the STAs communicate with each other without the intermediation of the AP, discovering the STA members of the P2P group, and assigning the GID. In another example, the associated STA may request to the AP various resources including QoS resources (e.g., SCS) for a specific GID and/or awake time windows (e.g., TWT) for STAs with power savings. There may be a P2P group data exchange in which the AP TXOP is shared.

The TXOP may be protected by the AP. That is, using a request to send (RTS) and clear to send (CTS), other STAs may be prevented from interrupting the ongoing P2P exchange between the STAs in the P2P group.

The STAs in the P2P group may be in power saving mode. To receive the trigger frame from the AP, the STAs in the P2P group may enter a target wake time (TWT) window. The AP may send the trigger frame to the STAs during the TWT window. In addition or alternatively, the STAs may enter the TWT window to receive a trigger frame from the AP. The TWT window may be arranged between the AP and the STAs in the P2P group before the P2P group is generated.

The AP may receive transmissions from the STAs in the P2P group before the trigger frame is sent to the STAs in the P2P group. For example, a first STA may send a transmission to the AP during an initial negotiation to signal inclusion in the P2P group. The first STA may signal inclusion of other members of the P2P group (e.g., centralize the negotiation), or different STAs may signal inclusion in the P2P group using different transmissions. In some examples, the P2P group may be 2, 3, or 4 devices. In some examples, the P2P group may be limited to a small number of devices (e.g., 4 devices).

The time allocated to the P2P group may continue until the shared gained TXOP for the P2P group ends. When the shared gained TXOP for the P2P group ends, the AP may recover the transmission opportunity allocated to the P2P group.

The AP may schedule its execution over time. In one example, the AP scheduling may be periodic. In another example, the AP scheduling may be aperiodic. The AP may create and announce the creation of the P2P group. The P2P group may be generated based on quality of service (QOS) standards. The AP may allocate a P2P time period (e.g., within the shared TXOP).

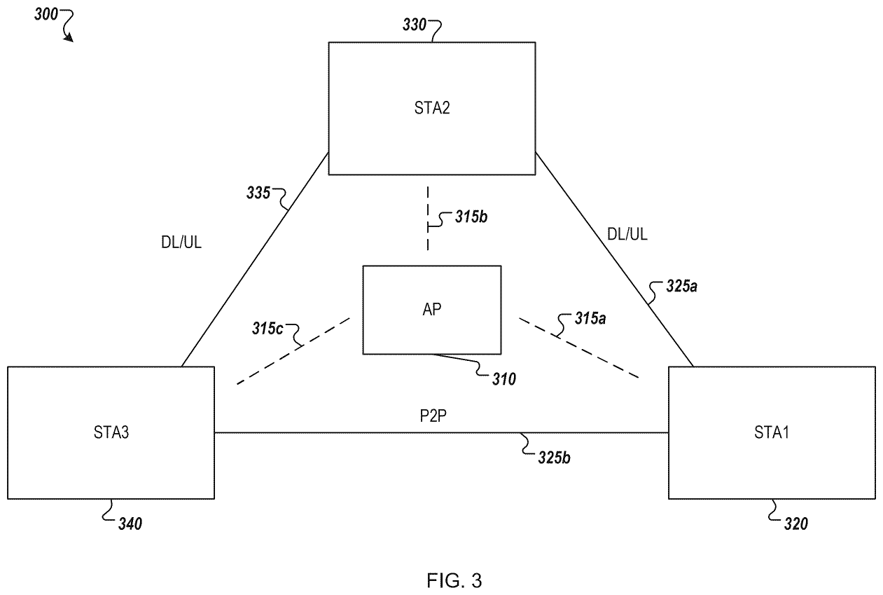

As illustrated in FIG. 3, an example wireless local area network environment 300 for P2P bidirectional data exchange for a P2P group of three devices may be a home networking application for video entertainment including a STA1 320 (e.g., a TV), a STA2 330 (e.g., sound speakers), a STA3 340 (e.g., Network Attached Storage (NAS)), and an AP 310.

The P2P group may be declared employing direct link EHT SCS requests sent to the AP 310 from the STAs 320, 330, 340 using direct links 315a, 315b, 315c. The AP 310 may recognize the standards for their common application service, and build the P2P group (e.g., including STAs 320, 330, and 340). The AP 310 may schedule its execution over the time (periodic or aperiodic). The creation of the P2P group may ensure that the specific P2P mechanism may be limited to that group, which may be allowed to use specific P2P group access mechanisms. STA 1 320 may be connected to STA2 330 using connection 325a and may be connected to STA3 using connection 325b. STA2 330 may be connected to STA3 340 using connection 335. In summary, the STAs 320, 330, 340 may request the creation of a common P2P group, the AP 310 may create and announce it based on QoS standards, and the AP 310 may signal the start of the P2P group within the shared TXOP, gained by the AP.

### P2P Access Mechanisms

### Triggered Access

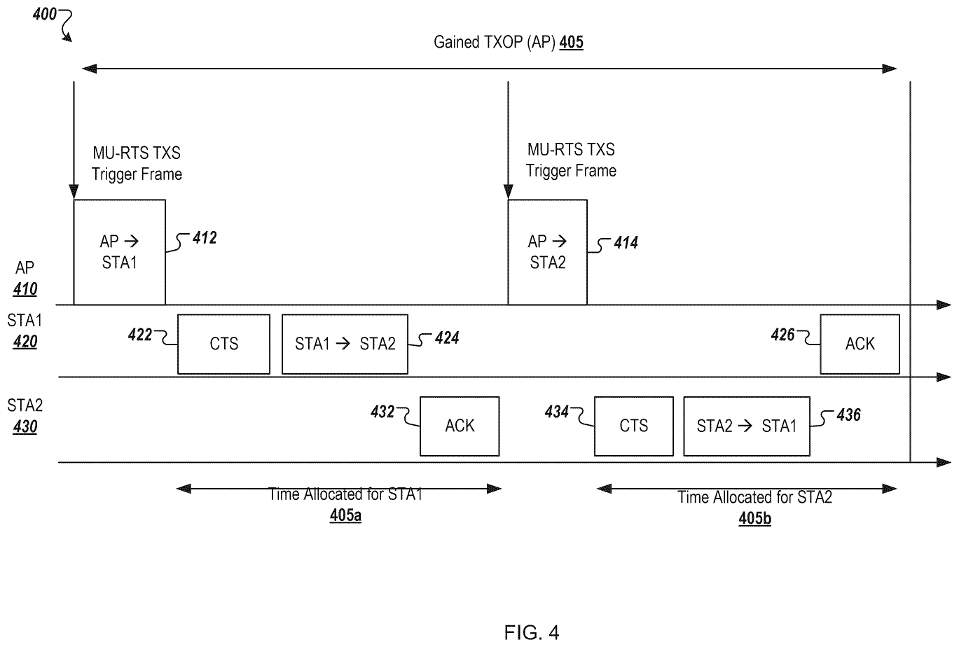

Triggered TXOP sharing mode 2 may have limitations for a generic P2P application case in which the AP creates P2P links for each direction sequentially, as illustrated in the diagram 400 in FIG. 4, the expected efficiency of P2P links may be lost when compared to a trigger-based communication managed by the AP in which the AP may not process the incoming STA frames and redirect them to its peer.

FIG. 4 shows the data exchange in two directions within the same AP TXOP (e.g., Gained TXOP (AP) 405), which may be divided into two independent sharing periods, one for each STA (e.g., time allocated for STA1 405a and time allocated for STA2 405b). This mechanism may allow the exchange of data in both directions between the two STAs 420, 430 from the same P2P group, avoiding contention for gaining the channel in each direction. The presented mechanism may have a similar frame exchange structure to the one provided by the AP using trigger-based frames. In both cases, AP scheduling capabilities may be used.

As illustrated in FIG. 4, an AP 410 may send a first MU-RTS TXS trigger frame to the first STA 420, as shown in operation 412. The AP 410 may send a second MU-RTS TXS trigger frame to the second STA 430, as shown in operation 414. The AP 410 may receive, at the AP 410 from the first STA 420, a first CTS frame, as shown in operation 422, and receive, at the AP 410 from the second STA 430, a second CTS frame, as shown in operation 434. The AP 410 may generate a first-direction P2P link and a second-direction P2P link. The AP 410 may generate the first-direction P2P link and the second-direction P2P link sequentially.

The STAs 420, 430 may send data between each other. STA1 420 may send data to STA2 430, as shown in operation 424. STA2 420 may send an ACK message to STA1 420, as shown in operation 432. STA2 430 may send data STA1 420, as shown in operation 436. STA1 may send an ACK message to STA1, as shown in operation 426.

### Light-Weight Contention

P2P links may alleviate the AP from overhead transferring data between STAs (unidirectional or bidirectional), which may increase the airtime efficiency and enhance P2P application performance. The triggered access mechanism, based on triggering the STA for sharing the TXOP, uses the intervention of the AP when the P2P application exchanges data in both directions.

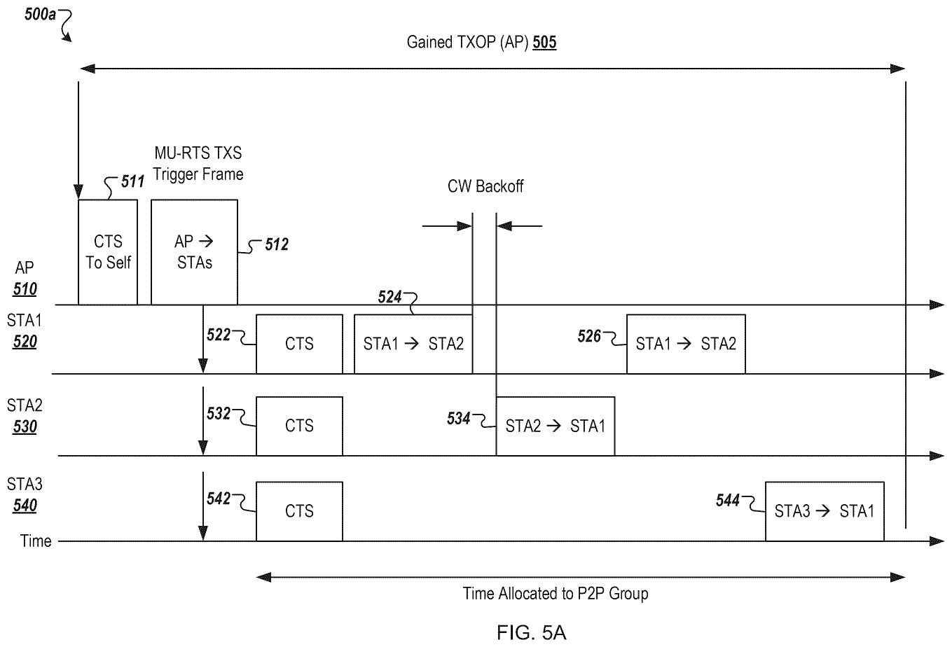

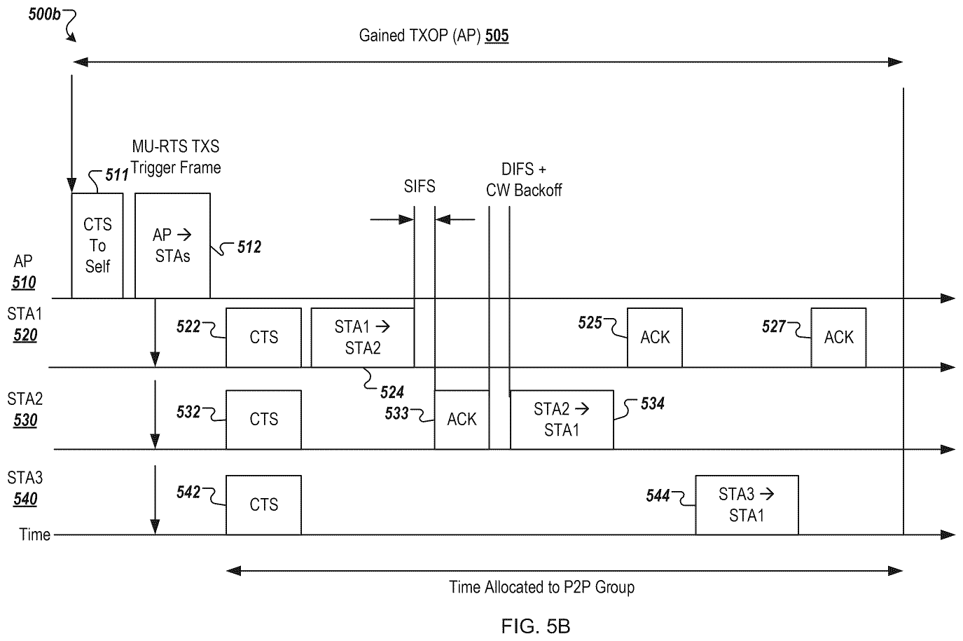

In the case of having a P2P group of three or more devices, the AP scheduling may be more complex. As shown in the timing diagram 500a in FIG. 5, the AP 510 may send the MU-RTS TXS Trigger frame to the P2P group, as shown in operation 512, and the P2P group (e.g., STA1 520, STA2 530, STA3 540) may send back a CTS frame, as shown in operations 522, 532, 542, acknowledging the AP 510.

When the P2P group includes a small number of devices (e.g., up to four devices), a low congested scenario may result. That is, the AP 510 may share the TXOP (e.g., gained TXOP) with the P2P group and create a contention time window for the STAs (e.g., STA1 520, STA2 530, STA3 540). Because the communication of these devices is driven by the P2P application, the shared TXOP may be restricted to a specific service or traffic priority. Consequently, there may not be many access collisions between the P2P group members. Therefore, channel access fairness within the same P2P group may be achieved.

A light-weight contention mechanism may reduce the time used to gain the channel when compared to the case of using Distributed Coordination Function (DCF) rules. The contention window (CW) back-off parameter may be smaller to reduce the time for accessing the channel and increase the efficiency by reducing the overhead. With one traffic priority service, distinction of access categories (ACs) may not be used; therefore the devices may start the contention after waiting for DCF InterFrame Space (DIFS) time. When acknowledgment frames are not used, the DIFS may be omitted because the DIFS allows for other devices to get access to the medium with a higher priority; therefore Short Interframe Space (SIFS) time may be used in the alternative. When acknowledgement frames are used, DIFS may be used because there may be frames with different priorities.

A STA may include a processing device that may (i) receive, at the STA from an access point (AP), a trigger frame including a shared gained TXOP for the STA and an additional STA; (ii) send, from the STA to the AP, a CTS frame; (iii) send, from the STA to an additional STA, first data during the shared gained TXOP of the trigger frame; and (iv) receive, at the STA from the additional STA, second data during the shared gained TXOP of the trigger frame. The trigger frame may be a MU-RTS TXS trigger frame.

The STA may receive, at the STA from the additional STA, an ACK message in response to sending the first data to the additional STA. The STA may receive the ACK message after an SIFS time. The STA may receive, at the STA from the additional STA, the second data after a CW back off. The STA may receive, at the STA from the additional STA, the second data after a DIFS time.

The STA may identify, at the STA, a fixed order of data transmission; and receive, at the STA from the additional STA, the second data after a fixed IFS separation. When a fixed order of data transmission is used, there may not be contention between the different STAs in the P2P group.

FIGS. 5A and 5B show reduced complexity contention mechanisms for a three-device P2P group, without acknowledgment and with acknowledgment mechanisms, respectively. In the first case, the STA devices skip DIFS and back-off a small contention window, expecting a very low rate of collisions, because the data traffic is driven by a common application service. In the case of using acknowledgment frames, the contention may allow these higher-priority frames. Therefore, the STA devices wait for DIFS time before starting with the back off time.

As illustrated in FIG. 5A, a timing diagram 500a is provided. A gained TXOP 505 may include a selected time duration. A time allocated to the P2P group may include a selected time duration (e.g., from the start of a CTS until the end of data transfer as shown by operation 544). An AP 510 may send a CTS-to-self signal, as shown in operation 511. The AP 510 may send an MU-RTS TXS trigger frame to STA1 520, STA2 530, STA3 540 as shown in operation 512. STA1 520 may send a CTS to the AP, as shown in operation 522. STA2 530 may send a CTS to the AP 510, as shown in operation 532. STA3 540 may send a CTS to the AP 510, as shown in operation 542. STA1 520 may send data to STA2 530, as shown in operation 524. After the data is sent from STA1 520 to STA2 530, a CW back-off may occur. The CW backoff may occur without waiting for a DIFS time. STA2 530 may send data to STA1 520, as shown in operation 534. STA1 520 may send additional data to STA2 530, as shown in operation 526. STA3 540 may send data to STA1 520, as shown in operation 544.

As illustrated in FIG. 5B, a timing diagram 500b is provided. Like numbers in FIG. 5B may have the same functionality as described with respect to like numbers in FIG. 5B. The data sent from STA1 510 to STA2 520, as shown in operation 524, may be acknowledged by STA2 520, as shown in operation 533. The data sent from STA2 530 to STA1 520, as shown in operation 534, may be acknowledged by STA1 520, as shown in operation 525. The data sent from STA3 540 to STA1 520, as shown in operation 544, may be acknowledged by STA1 520, as shown by operation 527.

The AP 510 may update the network allocation vector (NAV) counter of the network by sending a CTS-to-self frame, as shown in operation 511, and reserving the TXOP for itself. When the AP sends the Multi User (MU) Trigger frame to establish the P2P link, the AP resets the NAV counter of the P2P group, so the P2P group can start the contention for the channel. This is a light-weight DCF mechanism embedded within the shared TXOP, which may increase the airtime efficiency for a small number of P2P devices.

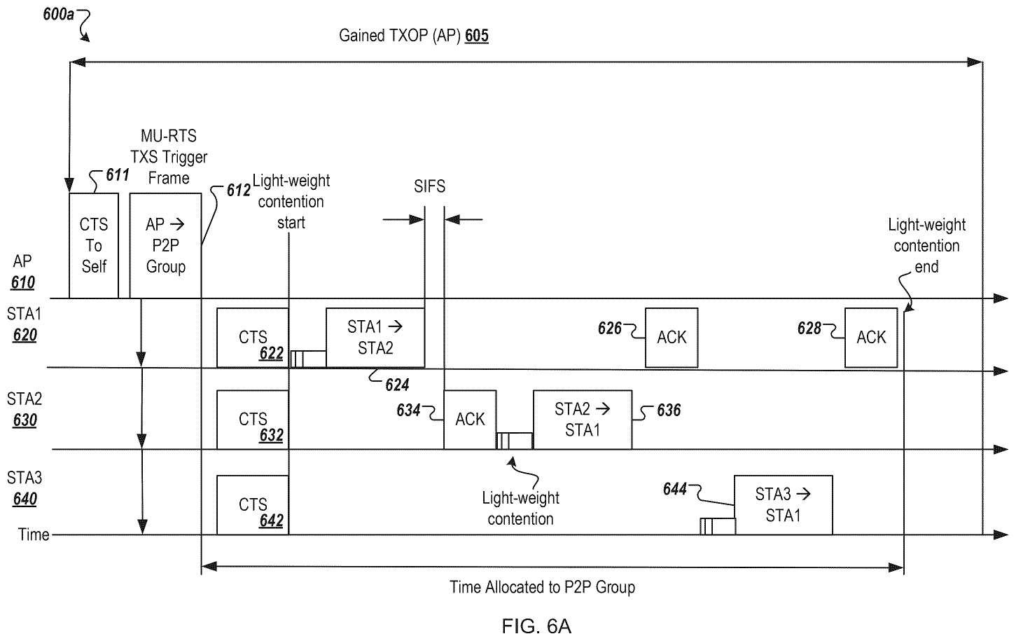

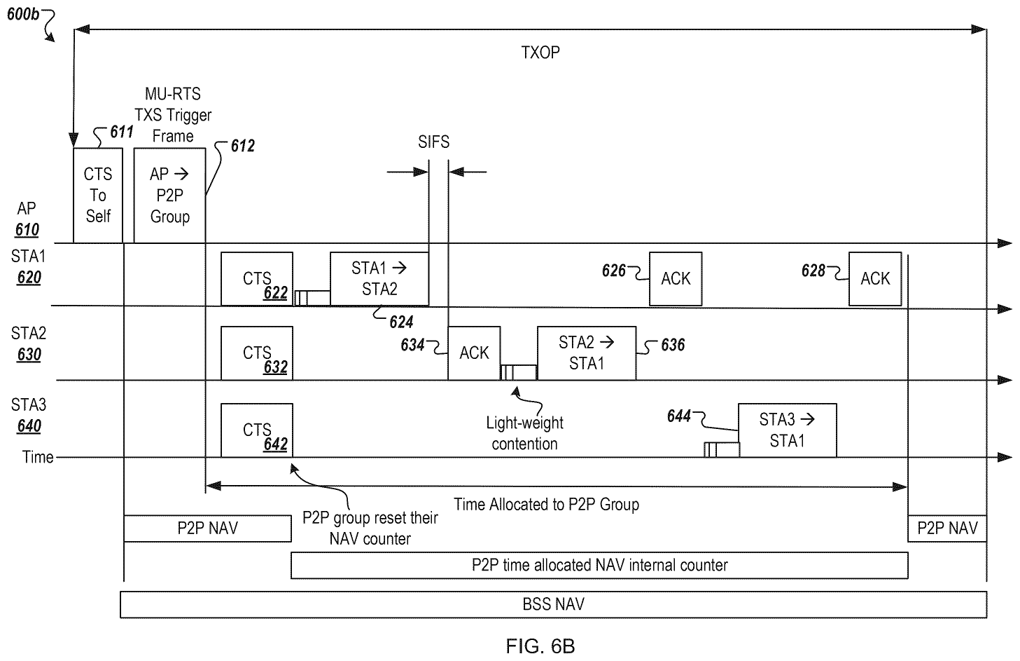

As illustrated in the timing diagram 600a in FIG. 6A, the AP's 610 granted TXOP (e.g., gained TXOP 605) time window may be seen as a local contention period for the P2P group (e.g., STA1 620, STA2 630, STA3 640) considered as a low congested scenario. The AP 610 may grant the time to allow data exchange in multiple directions within the group. To enhance the latency, the MU-RTS TXS trigger frame, sent by the AP 610, may include user information fields, to set the enhanced distributed channel access (EDCA) parameters of the P2P group (e.g., lowering arbitration inter-frame spacing (AISFN) and CW). Sending more than one user information field, covering the P2P group, may be used. The AP 610 may send a CTS to self, as shown in operation 611, and send an MU-RTS trigger frame from the AP to the P2P group, as shown in operation 612.

The triggered TXOP sharing mode may send the MU-RTS TXS trigger frame to the STA members in the P2P group (e.g., STA1 620, STA2 630, STA3 640). After the MU-RTS TXS trigger frame is received by the STA members in the P2P group, the STA members in the P2P group may send CTS frames to the AP, as shown in operations 622, 632, 642. After the CTS frames are sent, light-weight contention may start between the P2P group members (e.g., STA1 620, STA2 630, STA3 640) until the time allocated to the P2P group ends.

During a period of lightweight contention, STA1 620 may send data to STA2 630, as shown in operation 624. STA2 630 may send an ACK to STA1 620, as shown in operation 634. Before STA2 630 sends the ACK to STA1 620, there may be an SIFS. After STA2 630 sends the ACK to STA1 620, there may be lightweight contention. After the lightweight contention, STA2 630 may send data to STA1 620, as shown in operation 636. STA1 620 may send an ACK to STA2 630, as shown by operation 626. Another lightweight contention may occur before STA3 640 sends data to STA1 620, as shown by operation 644. STA 1 620 may send an ACK to STA3 640, as shown by operation 628. After operation 628, the period of light-weight contention may end. Thus, the period of lightweight contention starts after the CTS frames are sent and ends after the ACK from STA1 620 is sent to STA3. The period of lightweight contention is a subset of the time allocated to the P2P group.

A timing diagram is illustrated in FIG. 6B. Like numbers in FIG. 6B and FIG. 6A may have similar functionality. The NAV counter of the P2P group may be reset after sending the CTS frame, allowing the P2P group to start contending for the channel using the lightweight contention mode. Other STA devices, including overlapping basic service set (OBSS) devices, may not change the NAV, and may consider the channel as busy. Another internal time may count the remaining time for the allocated time. Once the allocated time finishes, the P2P group may restore the BSS NAV.

There may be several options for implementing the lightweight contention within the P2P group contention period. For example, high-performance EDCA parameters (AISFN and CW) may be used. The voice access category may be used to define these values. During the contention period there may be a small number of devices that are used. The devices may have quality of service (QOS) data traffic driven by the application, and there may be an order of transmission.

To summarize, a triggered TXOP sharing mode may be used which enables a light-weight contention period for QoS P2P group members. The MU-RTS TXS trigger frame may support more than one user information fields. The P2P group STAs may reset their NAV counter after sending the CTS frame, and start the light contention. The P2P group STAs may maintain an internal counter of the allocated time by the AP. After the allocated time expires, the P2P group STAs may recover the BSS TXOP NAV counter. There may be different light-weight contention options, according to application nature.

P2P communication links for some QoS time-sensitive applications, and current on-channel P2P mechanism limitations attending to bidirectional communication (closed loop) have been provided. Based on the P2P group concept, a triggered TXOP sharing mode may be used to allow direct communication with the P2P group. A light-weight contention mechanism may enhance the transmission efficiency and enhance the end-to-end communication latency.

There are various other ways of implementing P2P access mechanisms. In one example, no contention with fixed IFS may be provided. Assuming the application has a fixed order of data transmission, the contention may be removed, and set a fixed xIFS separation between the frames when there are no collisions.

In another example, token-based arbitration may be used. As an additional mechanism for avoiding collisions, there may be a token-based arbitration mechanism for allowing a P2P group member to transmit. The token may be passed through the members (different strategies may be used).

### Token-Based Channel Access

Instead of using a contention-based mechanism within the shared TXOP window, the P2P group may use a token-based mechanism to allow access to the channel to the P2P devices. The token may be signaled in the 802.11 MAC header or 802.11 PHY header (e.g., universal signal field (U-SIG) reserved bits), which may follow a round-robin algorithm. The token may use the STA ID, assuming that the P2P group devices know each other, to grant access to the next device. The token may be passed on the data frame, or until the STA transmission buffer is empty.

A station (STA) may include a processing device operable to: receive, at the STA from an access point (AP), a trigger frame; send, from the STA to the AP, a clear-to-send (CTS) frame; receive, at the STA from the AP, a channel access token; send, at the STA to a different STA, first data; send, at the STA to the different STA, the channel access token. The channel access token may include a station identifier. The channel access token may be signaled using one or more of an 802.11 medium access control (MAC) header or an 802.11 physical layer (PHY) header. The STA may receive, at the STA from the additional STA, an acknowledgment (ACK) message in response to sending the first data to the additional STA. The ACK message may be received after a short inter-frame space (SIFS) time. The trigger frame may be an MU-RTS TXS trigger frame.

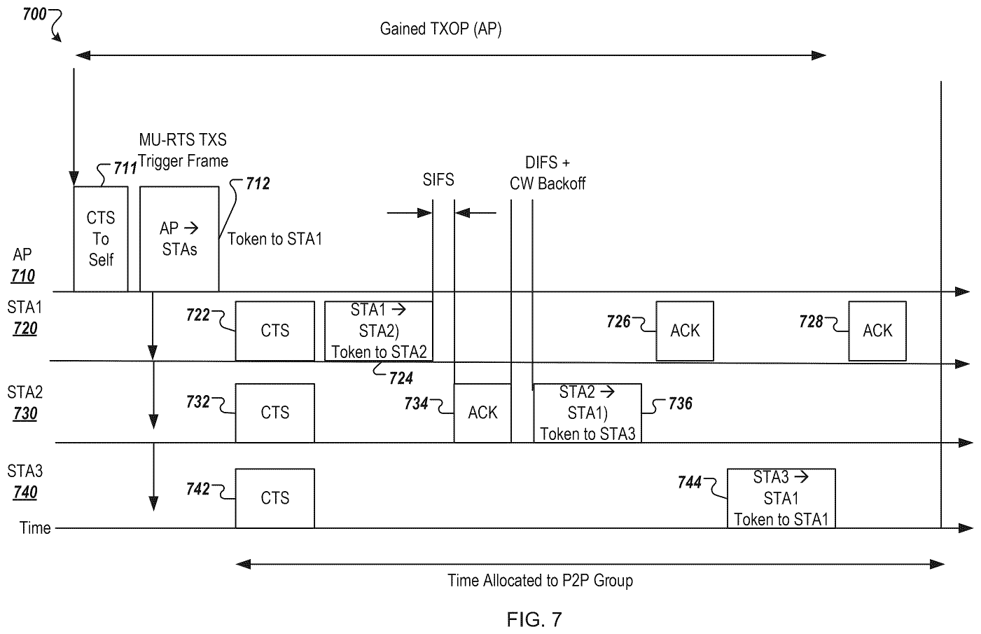

FIG. 7 shows an example timing diagram 700 of using a token-based mechanism for P2P frame exchange. The token may sent on the data frame, where the next STA may use a SIFS time after the acknowledgment frame of the previous transmission. When the channel access is arbitrated by the token, no collision may result along the shared TXOP time. At the beginning, the AP may update the NAV counter of the network devices. Each STA that receives the token may transmit frames.

As illustrated in FIG. 7, an AP 710 may send a CTS-to-Self to itself, as shown in operation 711. The AP 710 may send an MU-RTS TXS trigger frame to STA1 720, STA2 730, and STA3 740, as shown in operation 712. The AP 710 may send a token to STA1 720. STA1 720 may send a CTS to AP 710, as shown in operation 722. STA2 730 may send a CTS to AP 710, as shown in operation 732. STA3 740 may send a CTS to AP 710, as shown in operation 742. STA1 720 may send data to STA2 730 and may send a token to STA2 730, as shown in operation 724. After operation 724, an SIFS time may occur. After the SIFS time, STA2 730 may send an ACK to STA1 720, as shown in operation 734. After the ACK in operation 734, a DIFS and CW back-off may occur. STA2 730 may send data to STA1 720 and send a token to STA3 740, as shown in operation 736. STA1 720 may send an ACK, as shown in operation 726. STA3 740 may send data to STA1 720 and may send a token to STA1 720, as shown in operation 744. STA1 720 may send an ACK to STA3 740, as shown in operation 728. The time allocated to the P2P group may begin after operation 712 and may end after operation 728.

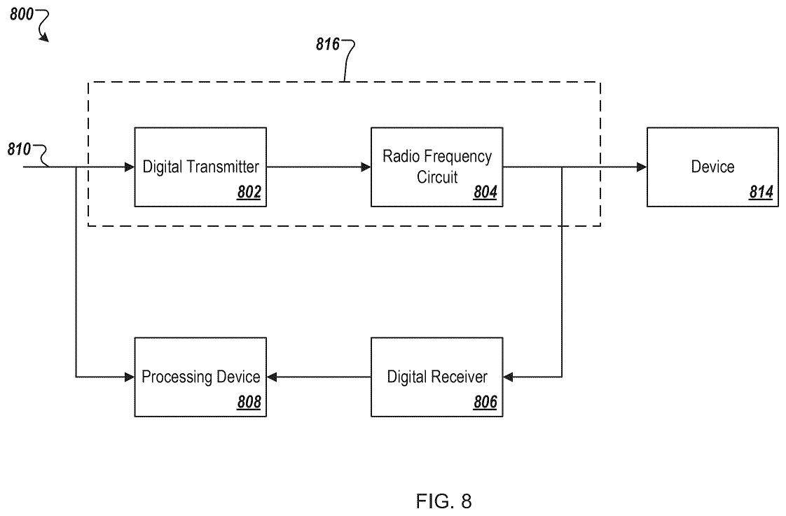

FIG. 8 illustrates a block diagram of an example communication system 800 configured for P2P communication, in accordance with at least one example described in the present disclosure. The communication system 800 may include a digital transmitter 802, a radio frequency circuit 804, a device 814, a digital receiver 806, and a processing device 808. The digital transmitter 802 and the processing device 808 may be configured to receive a baseband signal via connection 810. A transceiver 816 may comprise the digital transmitter 802 and the radio frequency circuit 804.

In some examples, the communication system 800 may include a system of devices that may be configured to communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may be configured to communicate via one or more wireless connections. For example, the communication system 800 may include one or more devices configured to transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may be configured to obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may be configured to obtain a baseband signal. For example, as described herein, the transceiver 816 may be configured to generate a baseband signal and/or receive a baseband signal from another device. In some examples, the transceiver 816 may be configured to transmit the baseband signal. For example, upon obtaining the baseband signal, the transceiver 816 may be configured to transmit the baseband signal to a separate device, such as the device 814. Alternatively, or additionally, the transceiver 816 may be configured to modify, condition, and/or transform the baseband signal in advance of transmitting the baseband signal. For example, the transceiver 816 may include a quadrature up-converter and/or a digital to analog converter (DAC) that may be configured to modify the baseband signal. Alternatively, or additionally, the transceiver 816 may include a direct radio frequency (RF) sampling converter that may be configured to modify the baseband signal.

In some examples, the digital transmitter 802 may be configured to obtain a baseband signal via connection 810. In some examples, the digital transmitter 802 may be configured to up-convert the baseband signal. For example, the digital transmitter 802 may include a quadrature up-converter to apply to the baseband signal. In some examples, the digital transmitter 802 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a power amplifier (PA), a digital transmitter (e.g., 802), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may be configured to obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may be configured to generate a baseband signal for transmission. In these and other examples, the transceiver 816 may be configured to transmit the baseband signal to another device, such as the device 814.

In some examples, the transceiver 816 may be configured to receive a transmission from the transceiver 816. For example, the transceiver 816 may be configured to transmit a baseband signal to the device 814.

In some examples, the radio frequency circuit 804 may be configured to transmit the digital signal received from the digital transmitter 802. In some examples, the radio frequency circuit 804 may be configured to transmit the digital signal to the device 814 and/or the digital receiver 806. In some examples, the digital receiver 806 may be configured to receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may be configured to communicate with additional devices and/or systems remote from the processing device 808, such as the transceiver 816 and/or the device 814. For example, the processing device 808 may be configured to send and/or receive transmissions from the transceiver 816 and/or the device 814. In some examples, the processing device 808 may be combined with other elements of the communication system 800.

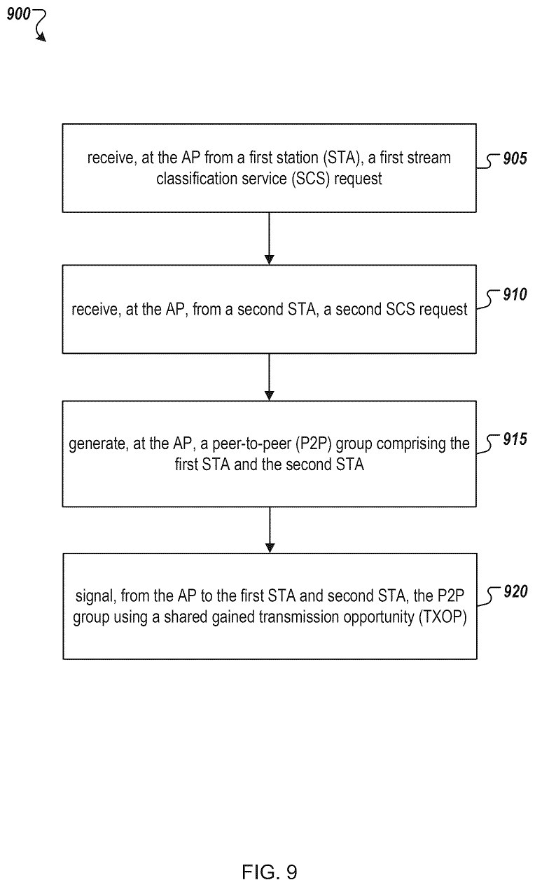

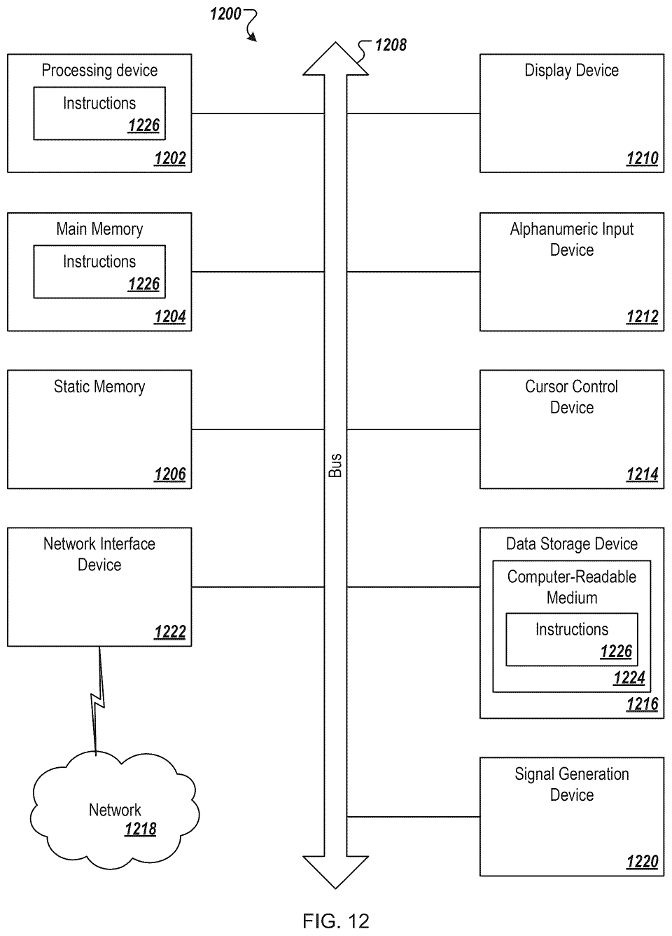

FIG. 9 illustrates a process flow of an example method 900 of P2P communication, in accordance with at least one example described in the present disclosure. The method 900 may be arranged in accordance with at least one example described in the present disclosure. The method 900 may be performed by processing logic that may include hardware (circuitry, dedicated logic, etc.), software (such as is run on a computer system or a dedicated machine), or a combination of both, which processing logic may be included in the processor (e.g., the processing device 1202 of FIG. 12), the communication system 800 of FIG. 8, or another device, combination of devices, or systems.

The method 900 may begin at block 905 where the processing logic may receive, at the AP from a first station (STA), a first stream classification service (SCS) request.

At block 910, the processing logic may receive, at the AP, from a second STA, a second SCS request.

At block 915, the processing logic may generate, at the AP, a peer-to-peer (P2P) group comprising the first STA and the second STA.

At block 920, the processing logic may signal, from the AP to the first STA and second STA, the P2P group using a shared gained transmission opportunity (TXOP).

Modifications, additions, or omissions may be made to the method 900 without departing from the scope of the present disclosure. For example, in some examples, the method 900 may include any number of other components that may not be explicitly illustrated or described.

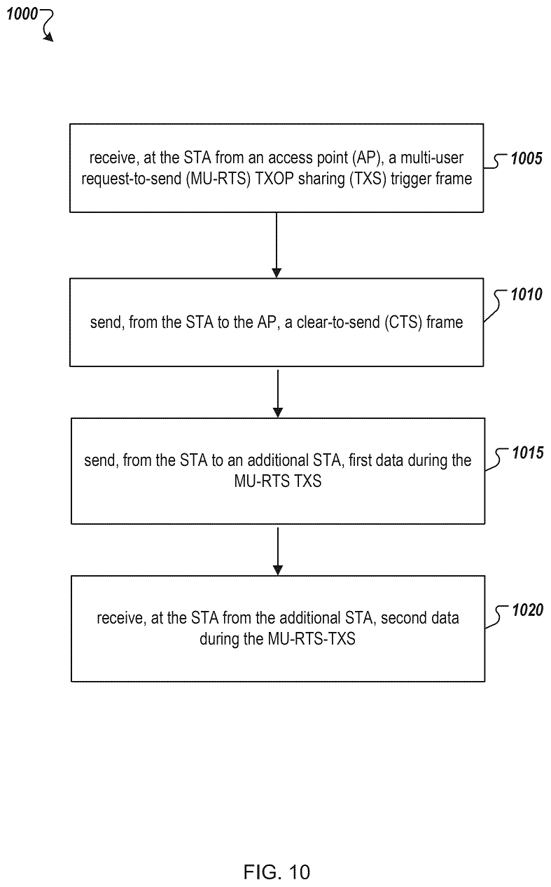

FIG. 10 illustrates a process flow of an example method 1000 of P2P communication, in accordance with at least one example described in the present disclosure. The method 1000 may be arranged in accordance with at least one example described in the present disclosure.

The method 1000 may be performed by processing logic that may include hardware (circuitry, dedicated logic, etc.), software (such as is run on a computer system or a dedicated machine), or a combination of both, which processing logic may be included in the processor (e.g., the processing device 1202 of FIG. 12), the communication system 800 of FIG. 8, or another device, combination of devices, or systems.

The method 1000 may begin at block 1005 where the processing logic may receive, at the STA from an access point (AP), a multi-user request-to-send (MU-RTS) TXOP sharing (TXS) trigger frame.

At block 1010, the processing logic may send, from the STA to the AP, a clear-to-send (CTS) frame.

At block 1015, the processing logic may send, from the STA to an additional STA, first data during the MU-RTS TXS.

At block 1020, the processing logic may receive, at the STA from the additional STA, second data during the MU-RTS-TXS.

Modifications, additions, or omissions may be made to the method 1000 without departing from the scope of the present disclosure. For example, in some examples, the method 1000 may include any number of other components that may not be explicitly illustrated or described.

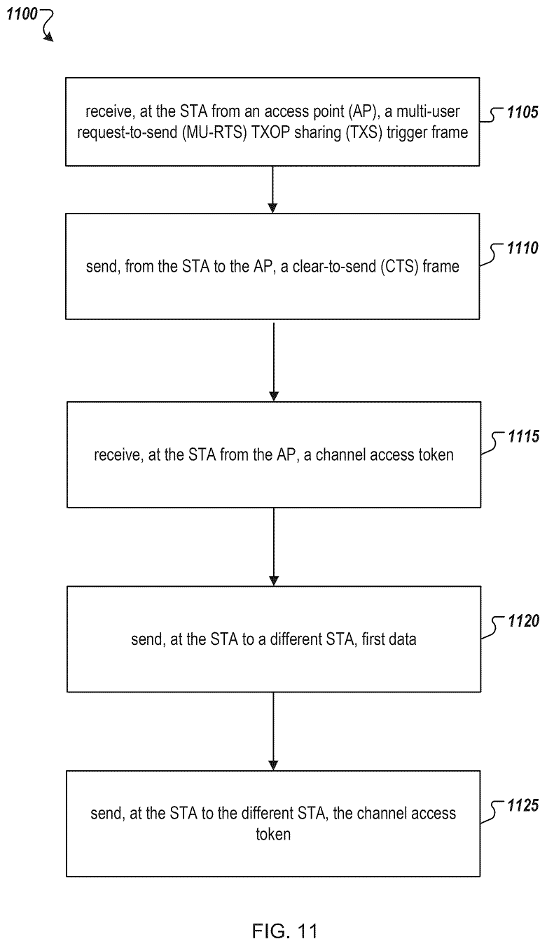

FIG. 11 illustrates a process flow of an example method 1100 of P2P communication, in accordance with at least one example described in the present disclosure. The method 1100 may be arranged in accordance with at least one example described in the present disclosure.

The method 1100 may be performed by processing logic that may include hardware (circuitry, dedicated logic, etc.), software (such as is run on a computer system or a dedicated machine), or a combination of both, which processing logic may be included in the processor (e.g., the processing device 1202 of FIG. 12), the communication system 800 of FIG. 8, or another device, combination of devices, or systems.

The method 1100 may begin at block 1105 where the processing logic may receive, at the STA from an access point (AP), a multi-user request-to-send (MU-RTS) TXOP sharing (TXS) trigger frame.

At block 1110, the processing logic may send, from the STA to the AP, a clear-to-send (CTS) frame.

At block 1115, the processing logic may receive, at the STA from the AP, a channel access token.

At block 1120, the processing logic may send, at the STA to a different STA, first data.

At block 1125, the processing logic may send, at the STA to the different STA, the channel access token.

Modifications, additions, or omissions may be made to the method 1100 without departing from the scope of the present disclosure. For example, in some examples, the method 1100 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 12 illustrates a diagrammatic representation of a machine in the example form of a computing device 1200 within which a set of instructions, for causing the machine to perform any one or more of the methods discussed herein, may be executed. The computing device 1200 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1200 includes a processing device 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate with each other via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one example, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1224 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP) comprising:
a processing device operable to:
identify, at the AP, a peer-to-peer (P2P) group comprising a first station (STA) and a second STA;
generate, at the AP, a shared gained transmission opportunity (TXOP) for the first STA and the second STA; and
send, from the AP to the first STA and second STA, a trigger frame including the shared gained TXOP.

2. The AP of claim 1, wherein the trigger frame facilitates generation of a first-direction P2P link and a second-direction P2P link.

3. The AP of claim 1, wherein the P2P group is identified using a group identifier (GID).

4. The AP of claim 1, wherein the processing device is further operable to send the trigger frame during a target wake time (TWT) window.

5. The AP of claim 1, wherein the processing device is further operable to receive a transmission from the first STA during an initial negotiation.

6. The AP of claim 1, wherein the processing device is further operable to recover a TXOP when time allocated to the P2P group in the shared gained TXOP ends.

7. The AP of claim 1, wherein the trigger frame is a multi-user request-to-send (MU-RTS) TXOP sharing (TXS) trigger frame.

8. The AP of claim 1, wherein the processing device is further operable to:
receive, at the AP from the first STA, a first clear-to-send (CTS) frame; and
receive, at the AP from the second STA, a second clear-to-send (CTS) frame.

9. A station (STA) comprising:
a processing device operable to:
receive, at the STA from an access point (AP), a trigger frame including a shared gained transmission opportunity (TXOP) for the STA and an additional STA;
send, from the STA to the AP, a clear-to-send (CTS) frame;
send, from the STA to an additional STA, first data during the shared gained TXOP of the trigger frame; and
receive, at the STA from the additional STA, second data during the shared gained TXOP of the trigger frame.

10. The STA of claim 9, wherein the processing device is further operable to:
reset, at the STA, a network allocation vector (NAV) counter to start a lightweight contention mode;
maintain, at the STA, an internal counter of allocated time from the AP; and
restore, at the STA, a basic service set (BSS) TXOP NAV counter for the STA when the allocated time expires.

11. The STA of claim 9, wherein the processing device is further operable to:
identify, at the STA, a fixed order of data transmission; and
receive, at the STA from the additional STA, the second data after a fixed inter-frame space (IFS) separation.

12. The STA of claim 9, wherein the trigger frame is a multi-user request-to-send (MU-RTS) transmission opportunity (TXOP) sharing (TXS) trigger frame.

13. The STA of claim 9, wherein the processing device is further operable to:
receive, at the STA from the additional STA, an acknowledgment (ACK) message in response to sending the first data to the additional STA.

14. The STA of claim 9, wherein the processing device is further operable to:
receive, at the STA from the additional STA, the second data after a contention window (CW) backoff.

15. The STA of claim 9, wherein the processing device is further operable to:
receive, at the STA from the additional STA, the second data after a distributed coordination function inter-frame space (DIFS) time.

16. The STA of claim 9, wherein the trigger frame includes a plurality of user fields to set one or more enhanced distributed channel access (EDCA) parameters for the STA and the additional STA.

17. A station (STA) comprising:
a processing device operable to:
receive, at the STA from an access point (AP), a trigger frame;
send, from the STA to the AP, a clear-to-send (CTS) frame;
receive, at the STA from the AP, a channel access token;
send, at the STA to an additional STA, first data; and
send, at the STA to the additional STA, the channel access token.

18. The STA of claim 17, wherein the channel access token comprises a station identifier.

19. The STA of claim 17, wherein the channel access token is signaled using one or more of an 802.11 medium access control (MAC) header or an 802.11 physical layer (PHY) header.

20. The STA of claim 17, wherein the trigger frame is a multi-user request-to-send (MU-RTS) TXOP sharing (TXS) trigger frame.
